(19) United States
(12) Patent Application Publication
(10) Pub. No.: US 2014/0059062 A1
(43) Pub. Date: Feb. 27, 2014

(54) INCREMENTAL UPDATING OF QUERY-TO-RESOURCE MAPPING

(71) Applicants: Jungho Ahn, Palo Alto, CA (US); Adam Sadovsky, Mountain View, CA (US)

(72) Inventors: Jungho Ahn, Palo Alto, CA (US); Adam Sadovsky, Mountain View, CA (US)

(73) Assignee: GOOGLE INC., Mountain View, CA (US)

(21) Appl. No.: 13/594,457

(22) Filed: Aug. 24, 2012

(51) Int. Cl. G06F 17/30

(52) U.S. Cl. 707/756; 707/E17.005

(57) ABSTRACT

Methods, systems, and apparatus, including computer programs encoded on computer storage media, for evaluating resource selection processes. One method includes, updating a query to resource mapping that associates each query of a group of queries with resources that match one or more of the queries for each of a plurality of predetermined periodic time intervals. For query in the group, the method includes identifying fresh resources that match the query, wherein each fresh resource is associated with a respective discovery time in the respective time interval, obtaining a respective query-specific score for each fresh resource that matches the query, identifying one or more fresh resources according to the query specific scores; and updating the query to resource mapping to include data that maps the query to the identified one or more fresh resources.

### BACKGROUND

This specification relates to evaluating automated resource selection processes for use by search engines.

Search engines, e.g., Internet search engines, provide information about resources, e.g., Web pages, images, text documents, multimedia content, that are responsive to a user's search query. Search engines return search results, e.g., as a ranked list of results, in response to a user-submitted query. A search result includes, for example, a link to, and a snippet of information from, a corresponding resource.

In order to identify the most responsive resources to a user's query, search engines build indexes that map words and phrases to resources determined to be relevant to the words and phrases. To build this index, search engines crawl available resources, e.g., by crawling the Internet. Index space is finite; therefore, search engines determine whether to include each resource that is crawled in the index. In some search engines, the determination of whether to include a particular resource in the search engine index is made according to an automated resource selection process. Automated resource selection processes analyze the values of one or more index selection signals for the resource to determine whether the resource should be included in the index. Each index signal is a metric of a quality of the resource derived by combining one or more attributes of a resource. Each index selection signal value is generally a scalar quantity derived from one or more attributes of the resource. Resource attributes can be internal to a resource, e.g., a number of words in a given resource or a length of the title of the given resource. Resource attributes can also be external to the resource, e.g., attributes derived from resources that link to a given resource or attributes derived from user behavior toward the resource.

### SUMMARY

In general, one innovative aspect of the subject matter described in this specification can be embodied in methods that include the actions of, for each of a plurality of predetermined periodic time intervals, updating a query to resource mapping that associates each query of a group of queries with resources that match one or more of the queries. For each query in the group, the method includes the actions of identifying fresh resources that match the query, wherein each fresh resource is associated with a respective discovery time in the respective time interval, obtaining a respective query-specific score for each fresh resource that matches the query, identifying one or more fresh resources according to the query specific scores, and updating the query to resource mapping to include data that maps the query to the identified one or more fresh resources. Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination.

Subsequent to an expiration of the plurality of predetermined periodic time intervals, the methods further include the actions of updating the group of queries by adding one or more new queries and removing one or more existing queries, and updating the query to resource mapping using the updated group of queries.

The methods further include the actions of receiving a test query, and generating, for the test query, a first group of resources corresponding to a first automated resource selection process and a second group of resources corresponding to a second automated resource selection process. The actions of generating the first group of resources include identifying, using the query to resource mapping, a plurality of resources that match the test query, determining, for each resource of the plurality of resources, whether the first automated resource selection process would classify the resource as to be indexed or not to be indexed, and then identifying all resources classified as to be indexed as the first group of resources, and determining, for each resource in the plurality of resources, whether the second automated resource selection process would classify the resource as to be indexed or not to be indexed, and then identifying all resources classified as to be indexed as the second group of resources.

For each resource of the plurality of resources that matches the test query, the methods further include the actions of deriving a respective first query-independent index selection score according to criteria associated with the first automated resource selection process, and classifying the resource as to-be-indexed if the query-independent respective index selection score satisfies a threshold, and otherwise classifying the resource or as not-to-be-indexed based on the first query independent index selection score, and deriving a respective second query-independent index selection score according to criteria associated with the second automated resource selection process, and classifying the resource as to-be-indexed if the respective query-independent index selection score satisfies a threshold, and otherwise classifying the resource or as not-to-be-indexed based on the second query independent index selection score.

For each resource of the plurality of resources that matches the test query, the methods further include the actions of classifying the resource as to-be-indexed if the first query-independent index selection score satisfies a threshold, and otherwise classifying the resource as not-to-be-indexed, and classifying the resource as to-be-indexed if the second query-independent index selection score satisfies a threshold, and otherwise classifying the resource as not-to-be-indexed.

For each resource of the plurality of resources that matches the test query, the method further include the actions of classifying the resource as to-be-indexed if the resource is one of a top predetermined number of resources according to the first query-independent index selection score, and otherwise classifying the resource as not-to-be-indexed, and classifying the resource as to-be-indexed if the resource is one of a top predetermined number of resources according to the second query-independent index selection score, and otherwise classifying the resource as not-to-be-indexed.

The criteria associated with the first automated resource selection process identifies a first plurality of index selection signals for use in deriving query-independent index selection scores, and the criteria associated with the second automated resource selection process identifies a second plurality of index selection signals for use in deriving query independent index selection scores.

The method of identifying the one or more fresh resources includes identifying the one or more highest scoring fresh resources according to the query-specific scores. The method of updating the query-to-resource mapping includes updating the query-to-resource mapping to include data that maps the query to the identified one or more highest scoring fresh resources.

Particular embodiments of the subject matter described in this specification can be implemented so as to realize one or more of the following advantages. Processing recently-discovered resources on a frequent basis enables a system to maintain an up-to-date mapping of a group of queries to resources that satisfy one or more of the queries in the group.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example index selection evaluation system.

FIG. 2 is a flow chart of an example method for selecting groups of resources for use in comparing automated resource selection processes.

FIG. 3 is a flow chart of an example method for comparing automated resource selection processes by comparing search results for groups of resources associated with the automated resource selection processes.

FIG. 4 illustrates an example graphical user interface for presenting two sets of search results in response to the same query.

FIG. 5 is a flow chart of an example method for comparing automated resource selection processes by comparing user selections of search results corresponding to different groups of resources associated with the automated resource selection processes.

FIG. 6A is a flow chart of an example method for generating a query-to-resource mapping that maps each query of a group of queries to resources that satisfy the queries.

FIG. 6B is a flow chart of an example method for incrementally updating a query-to-resource mapping with fresh resources.

FIG. 6C is a flow chart of an example method for incrementally updating a query-to-resource mapping with new queries.

FIG. 7 is a flow chart of an example method for determining whether to obtain a query-specific score for a resource that matches a query.

Like reference numbers and designations in the various drawings indicate like elements.

### DETAILED DESCRIPTION

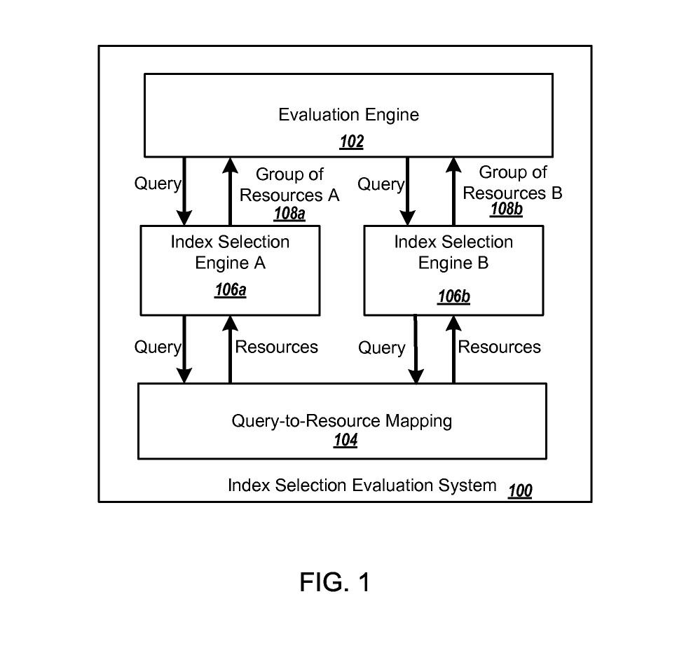

FIG. 1 is a block diagram of an example index selection evaluation system 100. The index selection evaluation system 100 includes an evaluation engine 102, a query-to-resource mapping 104, and one or more index selection engines 106a and 106b. While two index selection engines 106a and 106b are shown in FIG. 1, other numbers of index selection engines can alternatively be used. The index selection evaluation system 100 is implemented on one or more computers.

The evaluation engine 102 evaluates different automated resource selection processes. Each automated resource selection process determines whether individual resources should be included in an index of a search engine or should not be included in the index of the search engine. A resource is any data that can be provided by a website or other source, e.g., over a network or on a file system, and that is associated with a resource address or identifier, e.g., a Uniform Resource Locator (URL), a Uniform Resource Identifier (URI), or a file name. Examples of resources are HTML pages, word processing documents, portable document format (PDF) documents, presentation documents, images, videos, and feed sources. Each resource can include one or more kinds of content, e.g., words, phrases, and pictures, and can include embedded information, e.g., meta information and hyperlinks, or embedded instructions, e.g., JavaScript scripts.

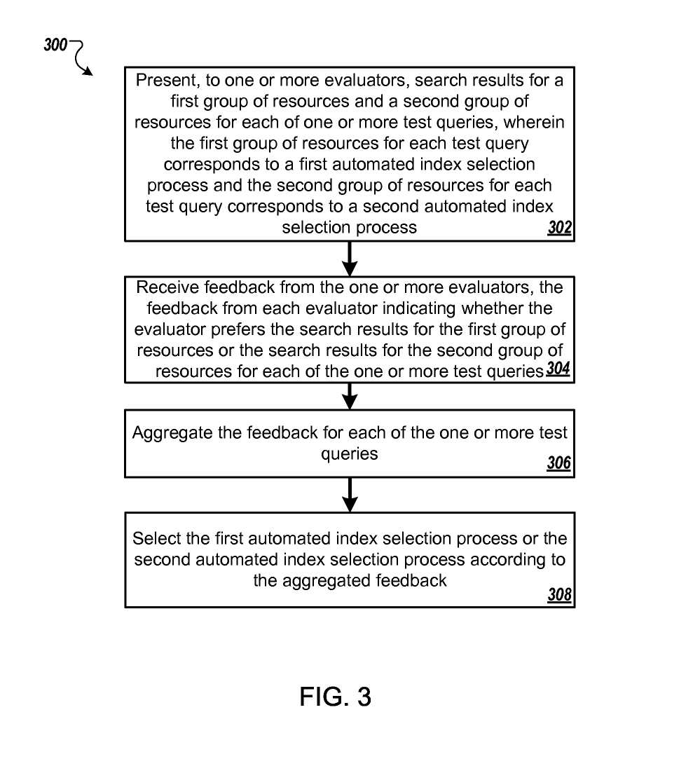

The evaluation engine 102 evaluates resource selection processes by comparing a group of resources for each process, for each of various queries. Each group of resources for a process and a query is the resources that the process would have included in an index and that satisfy the query. For example, in the example illustrated in FIG. 1, the groups of resources for a query are the group of resources A 108a for automated resource selection process A and the group of resources B 108b for automated resource selection process B. Different methods for evaluating resource selection processes by comparing groups of resources are described in more detail below with reference to FIGS. 3-5.

The evaluation engine 102 obtains the groups of resources 108a and 108b for each automated resource selection process from index selection engines 106a and 106b. While a separate index selection engine for each automated selection process is shown in FIG. 1, in alternative implementations, multiple automated selection processes share the same index selection engine.

The index selection engines 106a and 106b generate the groups of resources as follows. Each index selection engine 106a and 106b receives a query from the evaluation engine and obtains resources that match the query or data identifying the resources that match the query from the query-to-resource mapping 104.

The query-to-resource mapping can be implemented in a variety of ways. In some implementations, the mapping is implemented as a data structure that is directly accessed by the system using the mapping, whether to obtain or to update query or resource data. In other implementations, the mapping is implemented as one or more software components, for example, as a software object that encapsulates the mapping data and implements one or more interfaces that can be used by the system to obtain and update the mapping data. For example, as data structures, the mapping can be implemented as one or more tables that are stored on one or more computers. Alternatively, the mapping can be implemented as a list or tree data structure.

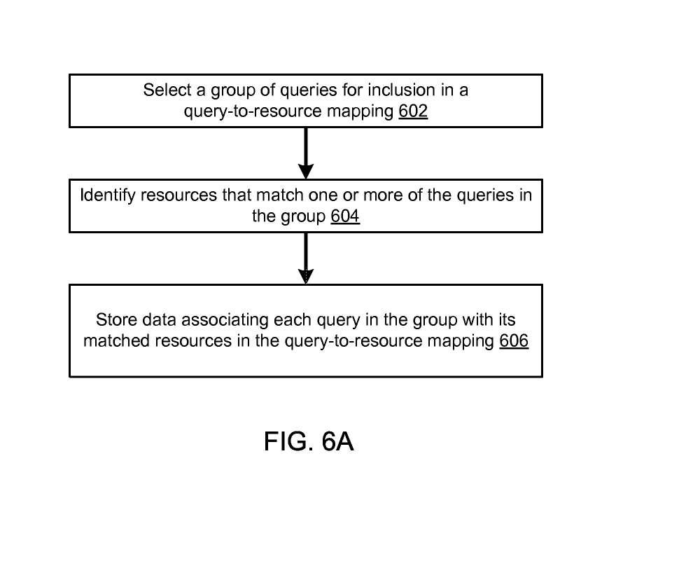

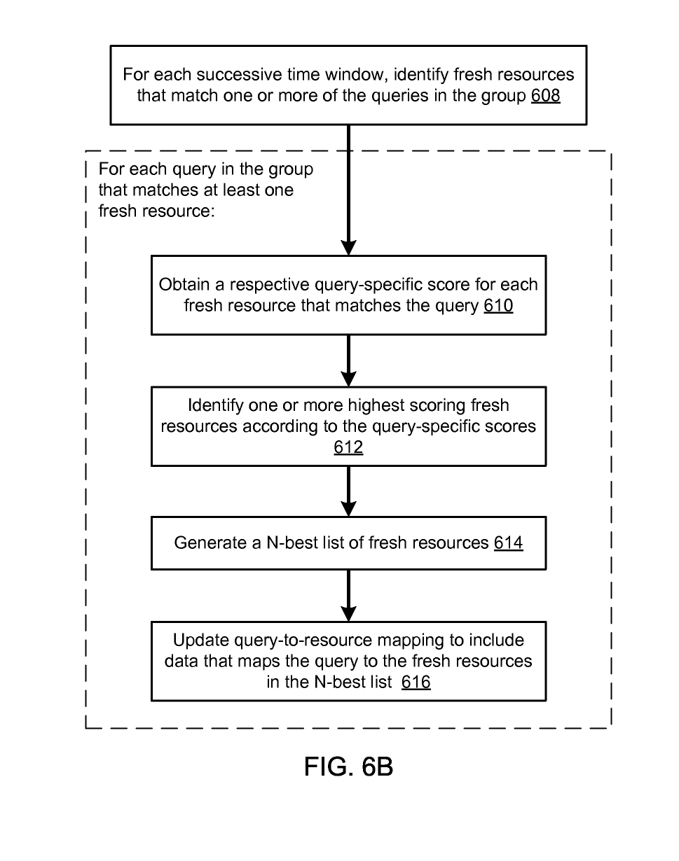

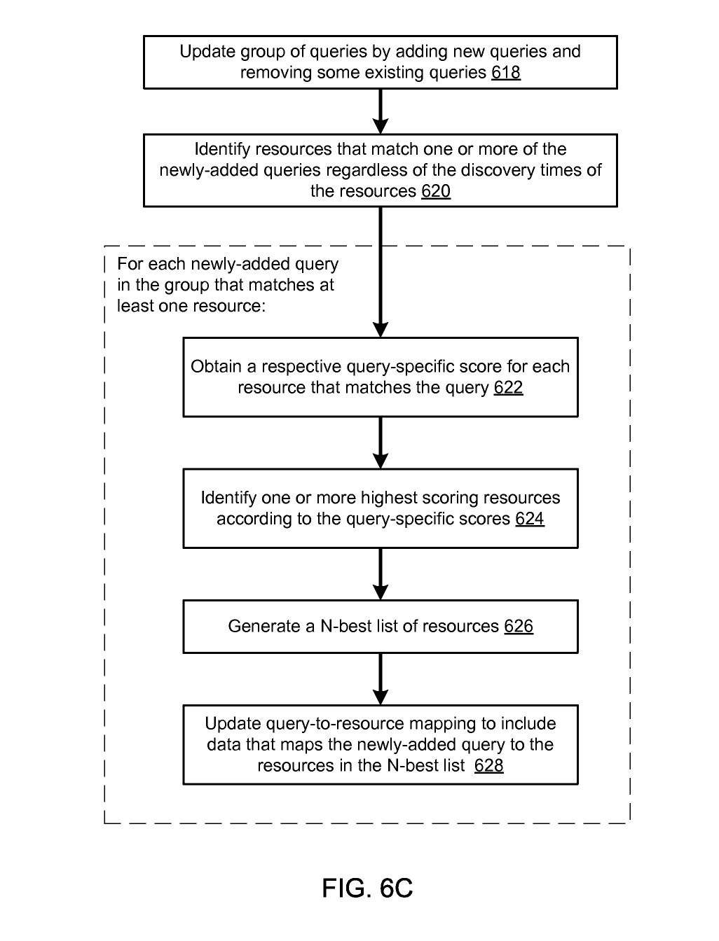

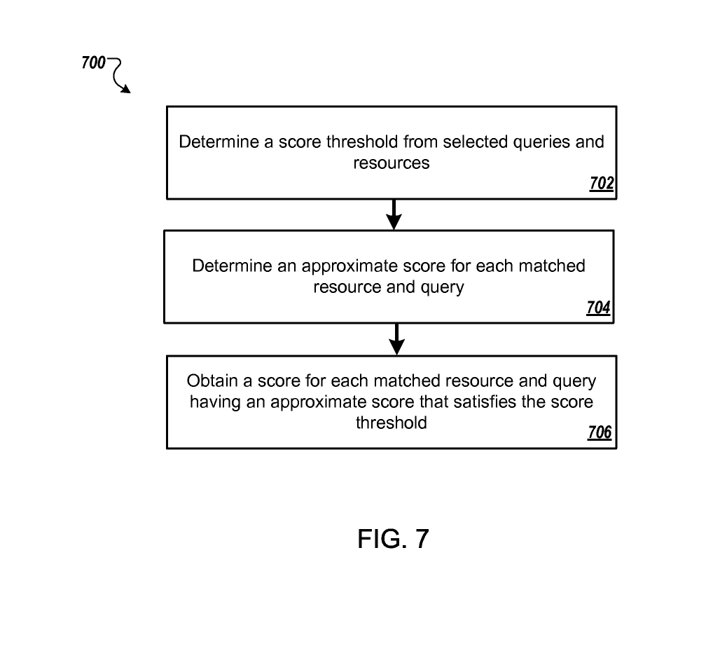

The query-to-resource mapping 104 stores data that associates queries with resources, e.g., resources crawled to build a search engine index. The query-to-resource mapping 104 is generated for a group of queries, each of which may be said to be “in” the query-to-resource mapping. Example methods for generating, then incrementally updating the query-to-resource mapping 104 are described in more detail below with reference to FIGS. 6-7.

Once the index selection engines 106a and 106b receive the resources, the index selection engines 106a and 106b classify each resource as one that would be included in a search engine index by their respective automated resource selection processes or as one that would not be included in the index by their respective automated resource selection processes. All resources that are classified as ones that would be included in the index by the automated resource selection process are sent to the evaluation engine 102 as a group of resources.

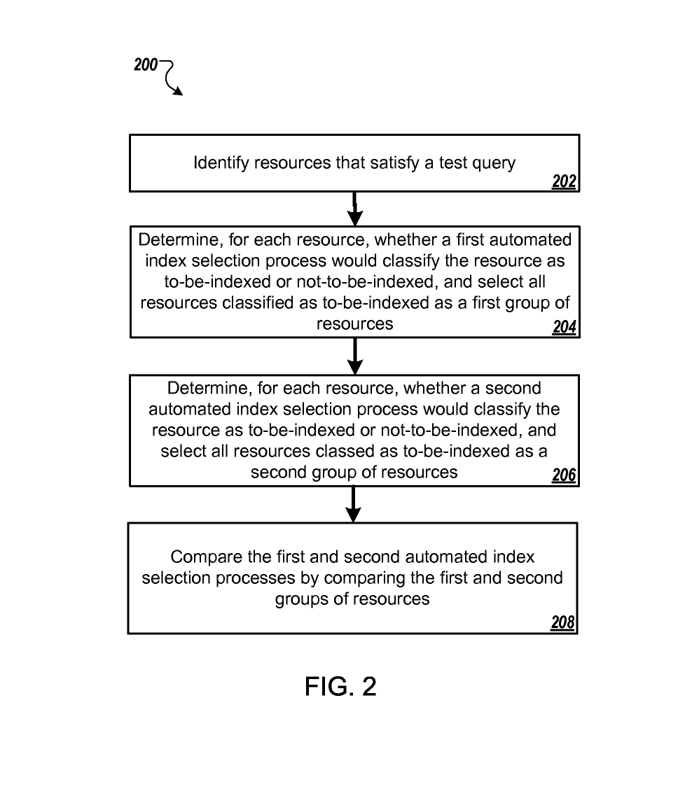

FIG. 2 is a flow chart of an example method 200 for selecting groups of resources for use in comparing automated resource selection processes. For convenience, the example method 200 is described in reference to a system of one or more computers that performs the method 200. The system can be, for example, the index selection evaluation system 100 described above with reference to FIG. 1.

The system identifies resources that match a test query (202). In some implementations, the system presents the test query to a query-to-resource mapping and receives resources from the query-to-resource mapping. In some implementations, rather than receiving the resources themselves, the system receives data identifying and characterizing the resources. This data can include, for example, an identifier of each resource and one or more indexing signals describing the resource. Example indexing signals are the length of the resource, the words in the title of the resource, an identifier of the resource, the length of the body text of the resource, a query-independent quality score for the resource, and user selection information for the resource, for example, a click-through-rate for the resource. In general, the indexing signals are signals describing the resource itself, independent of any specific query that the resource might satisfy. The indexing signals can be stored in a resource representation of each resource, can be extracted from the resources as needed, or can be retrieved from a lookup table that stores index signals for resources. Each indexing signal for a resource can be accessed through an application programming interface (API) that specifies a naming convention for the indexing signals.

The system determines, for each resource, whether a first automated resource selection process would classify the resource as to-be-indexed or as not-to-be-indexed, and selects all resources classified as to-be-indexed as a first group of resources (204). In some implementations, the determination of whether a given resource should be classified as to-be-indexed or not-to-be-indexed is made independently of the determinations made for any other resources. For example, the system can score each resource and compare the score to a threshold to determine the appropriate classification for the resource.

The system determines whether a first automated resource selection process would classify the resource as to-be-indexed or not-to-be-indexed by applying a heuristic associated with the first automated resource selection process. The heuristic corresponds to the formula the first automated resource selection process uses to generate scores for resources from signals describing the resources. This results in a single query-independent index selection score that is a summary of all of the signals used by the heuristic.

Each heuristic is specified by code that can be executed by the system. Each heuristic identifies the indexing signals it needs by invoking specific commands provided by an application programming interface (API). In some implementations, each heuristic is represented by a configuration file that identifies any parameters and formulas needed to generate the query-independent index selection score. A user can update the heuristics by editing the configuration file or editing any files that reference the configuration file and generate query-independent index selection scores.

The system compares the query-independent index selection score for each resource to a threshold. If the index selection score for the resource satisfies, e.g., exceeds, the threshold, the resource is classified as to-be-indexed. Otherwise, the resource is classified as not-to-be-indexed.

In some implementations, the threshold is a specified value that is associated with the first automated resource selection process. This value can be a fixed value.

Alternatively, the threshold can be determined based on the range of index selection scores calculated using the heuristic for the index selection process and the capacity of the index. For example, before the system selects resources for any particular query, the system, or another system, for example, a score generator made up of one or more computers that generate query-independent index selection scores, generates scores for a fixed percentage of the resources in the subset. For example, the system or the score generator can select a subset of the resources and generate a query-independent index selection score for each resource in the subset. From this, the system can estimate a score cutoff that will result in an index of the desired size. The size of the index can be measured in various ways. For example, the size can be the number of resources in the index or a resource cost of the resources in the index. An example resource cost is the physical storage space used to store data for the resources in the index. This resource cost can be estimated, for example, by a number of documents in the index or a number of tokens in the document. For example, the system can sort the subset of resources according to the query-independent index selection scores. The system can then start from the best-scoring resource and work down, adding each resource's size to a running total until the total is approximately equal to the desired size of the index times the fixed percentage. The system can then select the score for the last considered resource as the threshold value.

In some implementations, the system uses different thresholds for different types of resources. For example, the system can have different thresholds for resources in different languages.

For example, if the first automated resource selection process uses a query-independent quality score as the query-independent index selection score, and would include all resources with an query-independent quality score above a threshold in the index, the system can compare a query-independent quality score included in information received about each resource to the threshold, and classify resources whose query-independent quality score exceeds the threshold as to-be-indexed and resources whose query-independent quality score is less than or equal to the threshold as not-to-be-indexed.

The query-independent index selection score can be calculated according to a more complicated heuristic involving one or more signals and rules for adjusting the final index selection score based on signal values, for example, rules based on the number of characters in the resource, the number of links to the resource. For example, the system can start with a query-independent quality score for the resource, and then modify the score according to the following rules to obtain the final index selection score. If the identifier for the resource is longer than a pre-determined number of characters, the system multiplies the score by a first scoring factor. If the number of links to the resource from other resources is greater than a pre-defined number of links, the system multiplies the resulting score by a second scoring factor.

The system determines, for each resource, whether a second automated resource selection process would classify the resource as to-be-indexed or as not-to-be-indexed, and selects all resources classified as to-be-indexed as a second group of resources (206). The system makes the determination for the second automated resource selection process much as the system makes the determination for the first automated resource selection process.

In some implementations, the system caches the determination for one or more of the resources for the first automated resource selection process, the second automated resource selection process, or both automated resource selection processes. In these implementations, the system first checks the cache to see if a decision for a given resource is already stored before making the determination. If the decision is stored in the cache, the system uses the stored decision. Otherwise, the system makes the decision as described above.

The system compares the first and second automated resource selection processes by comparing the first and second groups of resources (208). Example methods for comparing the processes by comparing the groups of resources are described in more detail below with reference to FIGS. 3-5.

While the above description describes selecting groups of resources and comparing two automated resource selection processes, similar methods can be used to select groups of resources and compare more than two automated resource selection processes.

The above description describes a system in which a determination of whether a given resource should be classified as to-be-indexed or not-to-be-indexed is made independently of the determinations made for other resources. In some implementations of the system, the determination of whether a given resource should be classified as to-be-indexed or not-to-be-indexed is made based in part on the determinations made for other resources. For example, the system can score each resource, order the resources by score, classify each of the top predetermined number of resources as to-be-indexed, and classify each of the remaining resources as not-to-be-indexed.

FIG. 3 is a flow chart of an example method 300 for comparing automated resource selection processes by comparing groups of resources associated with the automated resource selection processes. For convenience, the example method 300 is described with reference to a system of one or more computers that performs the method. The system can be, for example, the index selection evaluation system 100 described above with reference to FIG. 1.

The system presents, to one or more evaluators, search results for a first group of resources and a second group of resources for each of one or more test queries (302). Each evaluator is a human being that views the two groups of resources and provides feedback on which group of resources the evaluator thinks is better. Each evaluator can make his or her decision based on specified factors or can make his or her decision based on personal, subjective feelings about the relative quality of the resources. In some implementations, all of the evaluators evaluate search results corresponding to each of the one or more test queries. In other implementations, at least some evaluators evaluate search results for less than all of the one or more test queries.

In other implementations, rather than using human evaluators, the system automatically evaluates the resources according to one or more predefined heuristics. For example, for each query, the system can identify the top ten resources according to a quality score for the resources. The system then evaluates each group of resources for the query by calculating the percentage of the top ten resources that are included in the group of resources selected for each resource selection process.

The first group of resources for each test query corresponds to a first automated resource selection process, and the second group of resources for each test query corresponds to a second automated resource selection process. The first groups of resources and the second groups of resources can be selected, for example, as described above with reference to FIG. 2.

The system presents the resources by presenting search results corresponding to the resources, e.g., in a user interface presented to each evaluator. Each search result presents information about a resource. For example, each search result can include a title of the resource, a URL that is an address of the resource, and an excerpt extracted from the resource.

In some implementations, the system determines an order for the resources and presents the search results according to the order. For example, the order can be the order that a search engine would use when presenting the search results to a user. The system can determine the order by instructing the search engine to determine a query-specific score for each resource before the resources are presented for a given query, and then ranking the search results according to the query-specific scores for the resources. Alternatively, the query-specific scores for the resources and each of a group of queries can be pre-computed by the search engine, e.g., at the time a query-to-resource mapping is constructed, and stored in the query-to-resource mapping as data associated with the resources identified for each query in the query-to-resource mapping.

In some implementations, the system presents search results corresponding to all of the resources in first group of resources and corresponding to all of the resources in second group of resources. In other implementations, the system presents search results corresponding to a proper subset of those resources. For example, the system can present search results corresponding to the top ten resources (or a different number of resources) in the first group of resources and search results corresponding to the top ten resources (or a different number of resources) in the second group of resources, according to the order for the first group of resources and the order for the second group of resources.

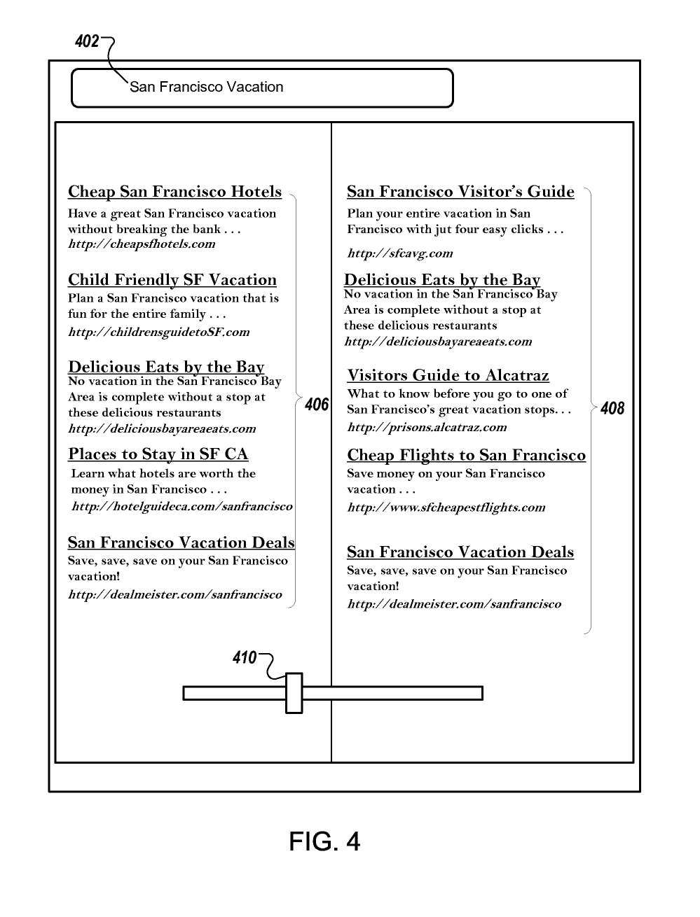

The system presents the search results in a manner that distinguishes the search results corresponding to the first group of resources from the search results corresponding to the second group of resources. For example, the search results can be presented side-by-side, where the search results corresponding to the first group of resources are on one side of a display and the search results corresponding to the second group of resources are on the other side of the display. An example of this type of presentation is described in more detail below, with reference to FIG. 4. As another example, the system can label the presentation of each search result, and use labels of one type for search results corresponding to resources in the first group of resources and labels of a different, second type for search results corresponding to resources in the second group of resources.

The system receives feedback from the one or more evaluators (304). The feedback from an evaluator indicates whether the evaluator prefers the search results corresponding to the first set of resources or the search results corresponding to the second set of resources for each of one or more test queries. The feedback can optionally include an indication of how much the evaluator prefers the first set of search results or the second set of search results. For example, each evaluator can provide a rating for the preferred set of search results. Each evaluator provides his or her feedback, for example, through an evaluation user interface. An example evaluation user interface is described in more detail below with reference to FIG. 4.

The system aggregates the feedback for each of the one or more test queries (306). The system aggregates the feedback to combine feedback received from multiple evaluators. For example, if the evaluation only indicates which set of search results was preferred, and six evaluators selected the first set of search results and two evaluators selected the second set of search results for a given test query, the system could count the number of selections of each set of search results, e.g., six and two, respectively. As another example, if the feedback includes a rating indicating how much a given set of search results was preferred, the system can sum the ratings for each set of search results. In other implementations, conventional statistical techniques are used to aggregate the ratings for the sets of search results.

The system selects the first automated resource selection process or the second automated resource selection process according to the aggregated feedback (308). The system can make this selection according to various heuristics. In some implementations, the system aggregates the feedback across all test queries, and compares the aggregated feedback for the automated resource selection processes that are being tested. The system then selects the automated resource selection process having the highest aggregated feedback across all queries.

In other implementations, the system determines a first number of test queries for which the number of evaluators that preferred the first set of search results exceeds the number of evaluators that preferred the second set of search results. The system also determines a second number of test queries for which the number of evaluators that selected the second set of search results exceeds the number of evaluators that selected the first set of search results. The system then compares the first number to the second number. If the first number exceeds the second number, the system selects the first automated index selection algorithm. If the second number exceeds the first number, the system selects the second automated index selection algorithm.

The numbers can optionally be weighted by the indication of how much more the evaluators preferred the search results. For example, if five evaluators preferred groups of resources for resource selection process A over groups of resources for resources selection process B by a rating of one, and three evaluators preferred groups of resources for resource selection process B over groups of resources for resource selection process A by a rating of three, the system could use 5×1=5 as the score for resource selection process A, could use 3×3=9 as the score for resource selection process B, and could select process B over process A as a result of the scores.

In some implementations, the system further considers other factors when selecting one of the resource selection processes over the other. For example, the system can consider the cost of evaluating each resource according to the heuristic associated with the resource selection process.

While the above description describes comparing two automated resource selection processes, similar methods can be used to compare more than two automated resource selection processes.

FIG. 4 illustrates an example graphical user interface for presenting two sets of search results 406 and 408 in response to the same query. The search results 406 and 408 correspond to resources that are selected according to two different automated resource selection processes. The user interface shown in FIG. 4 can be used, for example, to present sets of search results corresponding to resources selected according to different automated resource selection processes to evaluators and to receive feedback from the evaluators.

As shown in FIG. 4, two sets of search results are presented in response to the query “San Francisco Vacation” 402. The first set 406, includes search results corresponding to resources selected according to a first automated resource selection process. The second set 408 includes search results corresponding to resources selected according to a second automated resource selection process. The search results in both sets 406 and 408 are ordered according to an order that is the order a search engine would assign to the resources.

An evaluator can select one set of search results over the other by dragging, e.g., with a mouse or other input device, the slider bar 410 between the left side of the display and the right side of the display. The evaluator indicates how much better one set of search results is as compared to the other set of search results by how far to the left or right he or she drags the slider bar.

While the above description describes a user interface for comparing two automated resource selection processes, similar user interfaces can be used to receive feedback comparing more than two automated resource selection processes.

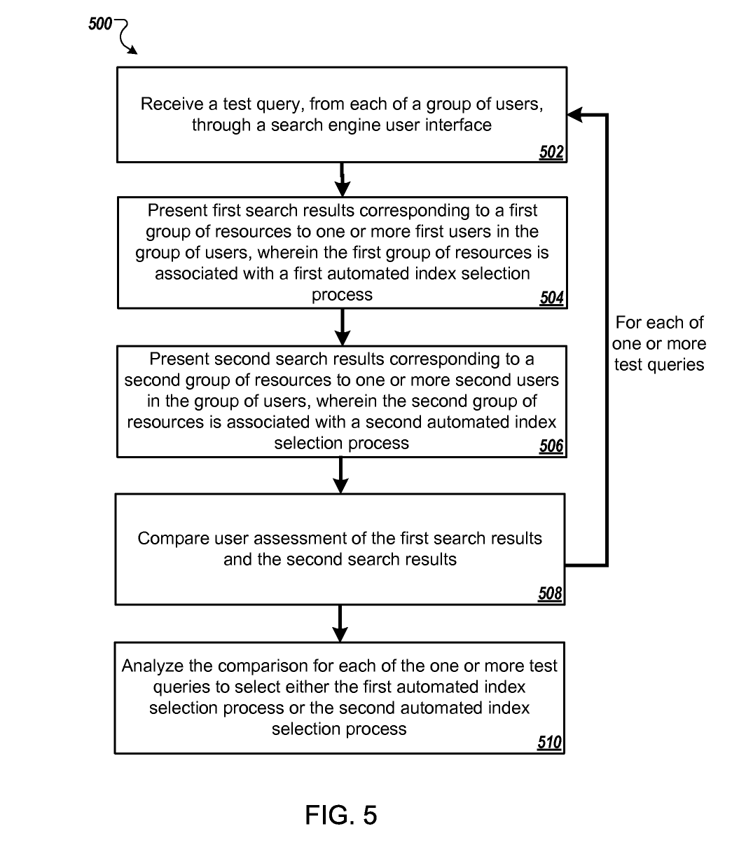

FIG. 5 is a flow chart of an example method 500 for comparing automated resource selection processes by comparing user selections of search results corresponding to different groups of resources associated with the automated resource selection processes. For convenience, the example method 500 is described with reference to a system of one or more computers that performs the method. The system can be, for example, the index selection evaluation system 100 described above with reference to FIG. 1.

The system performs the following steps for each of one or more test queries to collect data comparing user assessment of resources selected according to a first automated resource selection process with user assessment of resources selected according to a second automated resource selection process.

The system receives a test query, from each of a group of users, through a search engine user interface (502).

The system presents first search results corresponding to a first group of resources to one or more first users in the group of users (504). The first group of resources is associated with a first automated resource selection process. The first group of resources can be identified, for example, as described above with reference to FIG. 2.

The system presents second search results corresponding to a second group of resources to one or more second users in the group of users (506). The second group of resources can be identified, for example, as described above with reference to FIG. 2.

In some implementations, the system presents the first search results and the second search results in an order corresponding to an order they would be assigned by a search engine. The system can determine the order, for example, as described above with reference to FIG. 4.

The first users and the second users are different. The system can decide whether a given user is in the first group or users or the second group of users according to conventional experiment techniques. For example, the system can use one or more heuristics to make this determination. In some implementations, the system randomly selects users as being in the first group or the second group. In other implementations, the system selects users in one physical location as the first group of users and users in a second different physical location as the second group of users.

In some implementations, each user that issues one of the test queries is classified as either a first user or a second user. In other implementations, fewer than all of the users that issue one of the test queries are classified as either a first user or a second user. For example, the system can classify a first percentage of the users as first users and can classify a second percentage of the users as second users. The rest of the users can be shown default search results.

The system compares user assessment of the first search results and the second search results (508). The user assessment can take different forms. In some implementations, the system measures the user assessment by an aggregate click-through-rate for the search results. The click-through-rate for each individual search result can be calculated, for example, as follows:

$$\frac{number of times search result selected}{number of times search result presented to users} .$$

The system determines the aggregate click-through-rate for search results corresponding to a group of resources by summing the click-through-rates for each individual search result. Other techniques for determining an aggregate click-through-rate, for example, averaging, can also be used.

In other implementations, the system measures the user assessment by a length of time a user indicates interest in search results for the resources, e.g., by hovering a mouse or other input cursor over a search result, or by viewing the resource itself.

Once the system collects the comparisons for each of the one or more test queries, the system analyzes the comparisons for each of the one or more test queries to select either the first automated resource selection process or the second automated resource selection process (510). The system can use conventional statistical techniques to determine which resource selection process was preferred by the users. For example, the system can aggregate the click-through-rates for the search result corresponding to each group of resources selected using the first resource selection process to obtain an overall click-through-rate for the first resource selection process and can aggregate the click-through-rates for the search results corresponding to each group of resources selected using the second resource selection process to obtain an overall click-through-rate for the second resource selection process, and then select the resource selection process with the higher overall click-through-rate. Similar techniques of aggregating and comparing can be used for other types of user assessment. For example, if user assessment is measured by the length of time a user views a resource, the system can aggregate or average the length of time for resources selected using the first resource selection process and can aggregate or average the length of time for resources selected using the second resource selection process.

In some implementations, the system considers other factors in addition to the comparison of the user assessment, for example, as described in more detail above with reference to FIG. 4.

While the above description describes comparing two automated resource selection processes, similar methods can be used to compare more than two automated resource selection processes.

FIG. 6A is a flow chart of an example method for generating a query-to-resource mapping that maps each query of a group of queries to resources that match the query. For convenience, the example method will be described in reference to a system of one or more computers that performs the process. The system can be, for example, the index selection evaluation system 100 described above with reference to FIG. 1, or a different system.

The system selects a group of queries for inclusion in the query-to-resource mapping (602). In some implementations the system uses a heuristic to select queries from a group of candidate queries. For example, the candidate queries can be all queries submitted by users to a search engine during a given time period, e.g., over the last three months. The system can then select queries from the group of candidate queries according to a selection heuristic. For example, the system can randomly select queries, or can focus on rare queries by selecting queries that are submitted less than a threshold number of times by users, or select queries that have been in the system for at least a threshold number of days. In some implementations, the system selects the queries so that a pre-determined number of queries from each of one or more locales are selected. A locale is, for example, a country, a language, or a country and a language pair. In some implementations, the system receives the queries from another system that samples query logs. In other implementations, the system directly samples query logs. The query log data is maintained in anonymized form to protect user privacy. This does not affect the operations of the system. In implementations where the system directly samples the query logs, the system preferably takes actions to anonymize the query log data and protect user privacy. In some implementations, the system samples the query logs using programs implemented with a MapReduce framework and programming model. For example, the system can use a map step that processes the logs and outputs queries keyed by locale. The reduce step can then sample a pre-determined number N of queries from each locale using conventional statistical sampling techniques.

In other implementations, human users of the system select, or help select, the queries, and instruct the system to use the selected queries. In some implementations, queries are selected that are expected to have a small number of matching resources, e.g., a number of resources that can be accommodated by the storage space allocated to the query-to-resource mapping.

In still other implementations, the system uses a combination of heuristic query selection and human intervention to select the queries.

The system identifies resources that match one or more of the queries in the group (604). The resources can be, for example, resources discovered by a search engine as part of the process of building a search engine index that have terms that match the terms of one or more of the queries. The system can identify the resources as they are being crawled, or can alternatively process data collected for the resources during the crawling process after the crawling process has been completed.

In some implementations, the system considers all resources crawled by the search engine. In other implementations, the system considers all resources crawled by the search engine up to a predetermined depth. The depth can be selected to be deeper than the depth usually used when the search engine is building an index. When the selected depth is deeper than the depth used when the search engine is building an index, the system identifies resources that the search engine does not include in its index.

The system determines if a given resource matches a given query by determining if one or more terms, e.g., words or phrases, in the query appear in the resource. In some implementations, the system modifies each query, for example, through stemming, normalization, adding synonyms, or other techniques, and tries to match the resource to the modified query rather than the original query. In general, the system performs the same query modifications that the search engine for which the automated index selection algorithms are being tested would perform.

In some implementations, the system also obtains a respective query-specific score for each matched resource and query, for example, by requesting a query-specific score for the matched resource and query from the search engine for which the automated resource selection processes are being tested. The query-specific score can later be used to rank resources responsive to a test query, for example, as described above with reference to FIG. 3.

In some implementations, rather than obtaining a respective query-specific score for each matched resource and query, the system first identifies matches that are estimated to have a query-specific score that satisfies a score threshold and obtains only those query-specific scores. An example method for determining which matches are estimated to have a good query-specific score is described in more detail below with reference to FIG. 7.

The system stores data associating each query in the group with its matched resources in the query-to-resource mapping (606). In implementations where the system determined a query-specific score for each matched resource and query, the system associates each query with the query-specific score for the resource. In implementations where the system only determined a query-specific score for some of the matched resources and queries, the system only associates the queries with resources that were scored for the queries.

In some implementations, the system assigns an order to the resources matching each query according to the associated query-specific scores for the resources and the query.

In some implementations, the system identifies index selection signals for inclusion in the query-to-resource mapping. Each index selection signal is derived from one or more resource attributes. The identified index selection signals include all signals used by any of the resource selection processes that may be tested. In such implementations, the system can obtain index selection signal values for each resource and store the obtained index signal values along with the data associating each query with all matching resources. The index selection values can be obtained, for example, by accessing code referenced through the application programming interface (API) for index selection signals. In some implementations, the index selection signals are stored separately from the query-specific ranking scores for each resource.

FIG. 6B is a flow chart of an example method for incrementally updating a query-to-resource mapping with fresh resources. The example method of FIG. 6B will be described with reference to query-to-resource mapping that was generated using the method of FIG. 6A.

As shown in FIG. 6B, the system incrementally updates the query-to-resource mapping to associate each query in a group of queries with fresh resources that match the queries. In one example scenario, the system incrementally updates the query-to-resource mapping periodically, e.g., at the end of successive six, twelve, twenty-four, thirty-six, forty-eight, sixty, or seventy-two hour time windows.

For each successive time window, the system identifies fresh resources that match one or more of the queries (608). Each identified fresh resource is a resource that is associated with a discovery time that falls in the time window. The discovery time can be the time at which the resource was first crawled, in its present form, by the system 100, for example.

For each query in the group that matches at least one fresh resource, the system obtains a respective query-specific score for each fresh resource that matches the query. The score can be obtained from the search engine for which the automated resource selection processes are being tested (610). The system identifies one or more highest scoring fresh resources (612), and generates a N-best list of fresh resources for the query according to the query-specific scores (614). In some implementations, the N-best list of fresh resources represents a top 100, 200, 500, 750, 1,000, 2,000, 5,000, or 10,000 highest scoring fresh resources that match the query. Finally, the system updates the query-to-resource mapping to include data that maps the query to the fresh resources in the N-best list of resources for the query (616).

FIG. 6C is a flow chart of an example method for incrementally updating a query-to-resource mapping with new queries. The example method of FIG. 6C will be described with reference to a query-to-resource mapping that was generated using the method of FIG. 6A and, optionally, updated using the method of FIG. 6B.

As shown in FIG. 6C, the system first updates the group of queries in the query-to-resource mapping by adding some new queries and removing some existing queries (618). In some implementations, the system replaces a predetermined fraction, e.g., 5%, 10%, 15%, 20%, or 25%, of the existing queries with new queries at predetermined periodic time intervals, e.g., at the end of each successive one week, two week, four week, eight week, or twelve week time window.

Next, the system identifies all resources that match one or more of the newly-added queries regardless of the discovery times of the resources (620).

For each new query in the group that matches at least one resource, the system obtains a respective query-specific score for each resource that matches the newly added query from the search engine for which the automated resource selection processes are being tested (622), identifies one or more highest scoring resources according to the query-specific scores (624), and generates a N-best list of resources for the newly-added query (626). In some implementations, the N-best list of resources represents the top 500, 750, 1,000, 1,250, 1,500, or 2,000 highest scoring resources that match the newly added query. Finally, the system updates the query-to-resource mapping to include data that maps the newly-added query to the resources in the N-best list of resources for the query (628).

FIG. 7 is a flow chart of an example method 700 for determining whether to obtain a query-specific score for a matched resource and query, and then obtaining the query-specific score when appropriate. For convenience, the example method 700 will be described in reference to a system of one or more computers that performs the process. The system can be, for example, the index selection evaluation system 100 described above with reference to FIG. 1, or a different system.

The system determines a score threshold from selected queries and resources (702). The selected queries can be selected, for example, as described above. The resources are the resources being considered for inclusion in the query-to-resource mapping.

In some implementations, the system obtains the score threshold as follows. First, the system matches a proper subset of the resources, e.g., 1% of the resources, against all of the selected queries. The system selects this subset, for example, using random sampling. The system then obtains a query-specific score for each resource for each query matched to the resource, for example, as described above with reference to FIG. 6. The system then uses the obtained query-specific scores to calculate the score threshold.

The system selects the score threshold according to the obtained query-specific scores and an amount of storage space allocated to the query-to-resource mapping. The system uses the subset of the resources as a sample of the entire population of resources, and selects the threshold accordingly. For example, if the system is trying to select N resources for each query, and the matched and scored subset of the resources is x percent of the total resources that match the query, the system identifies a threshold that would result in keeping matching resources having a total size of

$$\frac{N \times x}{100} .$$

The system ranks the matches of resources and queries according to their query-specific scores for each query, identifies the resource and matched query that would result in a size of approximately

$$\frac{N \times x}{100} ,$$

and uses the query-specific score of the identified resource for the identified query as the score threshold.

The system determines an approximate score for each matched resource and query (704). The approximate score is calculated according to a heuristic designed to approximate the actual query-dependent score for the resource, but with less computational overhead. For example, the algorithms used to generate the approximate score can be optimized for the comparison of one query to many documents. In some implementations, the algorithms are selected to give a conservatively high estimate of the score that a full scoring function will assign.

The system obtains a score for each matched resource and query having an approximate score that satisfies the score threshold (706). The system can obtain the score, for example, as described above with reference to FIG. 6.

In some implementations, the system selects the threshold and performs the matching and scoring of the resources using programs implemented with a MapReduce framework and programming model.

For example, in some implementations, the system determines the threshold as follows. The system performs a map step that loads the queries into memory and processes the subset of resources one at a time. For each resource, the map step finds all matching queries and estimates a score for each matched resource and query, as described above. The output of the map step is the query mapped to the estimated scores for each resource matched to the query. The system then performs a reduce step that sorts the resources for each query by the estimated scores and identifies the appropriate threshold as described above.

In some implementations, the system performs the matching and scoring to build the full query-to-resource mapping as follows. The system first performs a map step that loads all queries of the query set into memory and processes one resource at a time. For each resource, the system identifies all matching queries, calculates the score estimate for each query, and if the score estimate is above a threshold, calculates the full score for the query and the resource. The map step outputs queries mapped to resources and full scores, along with any data needed to return search results to users. The reduce step then sorts the resources for each query by score.

The system then performs a second map reduce that associates any needed index selection signal values with each resource. The map reduce for generating the full query-to-resource mapping can be split into multiple map reduces for different resources. In such implementations, the second map reduce can also merge the results from the multiple map reduces.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions encoded on a computer storage medium for execution by, or to control the operation of, data processing apparatus. Alternatively or in addition, the program instructions can be encoded on a propagated signal that is an artificially generated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
for each of a plurality of predetermined periodic time intervals, updating a query-to-resource mapping that associates each query of a group of queries with resources that match one or more of the queries, including, for each query in the group:
identifying fresh resources that match the query, wherein each fresh resource is associated with a respective discovery time in the respective time interval;
obtaining a respective query-specific score for each fresh resource that matches the query;
identifying one or more fresh resources according to the query-specific scores; and
updating the query-to-resource mapping to include data that maps the query to the identified one or more fresh resources.

2. The computer-implemented method of claim 1, further comprising:
subsequent to an expiration of the plurality of predetermined periodic time intervals,
updating the group of queries by adding one or more new queries and removing one or more existing queries; and
updating the query-to-resource mapping using the updated group of queries.

3. The computer-implemented method of claim 1, further comprising:
receiving a test query; and
generating, for the test query, a first group of resources corresponding to a first automated resource selection process and a second group of resources corresponding to a second automated resource selection process, wherein the generating includes:
identifying, using the query-to-resource mapping, a plurality of resources that match the test query;
determining, for each resource of the plurality of resources, whether the first automated resource selection process would classify the resource as to-be-indexed or not-to-be-indexed, and then identifying all resources classified as to-be-indexed as the first group of resources; and
determining, for each resource in the plurality of resources, whether the second automated resource selection process would classify the resource as to-be-indexed or not-to-be-indexed, and then identifying all resources classified as to-be-indexed as the second group of resources.

4. The method of claim 3, wherein, for each resource of the plurality of resources that matches the test query, the method further comprises:
deriving a respective first query-independent index selection score according to criteria associated with the first automated resource selection process, and classifying the resource as to-be-indexed or as not-to-be-indexed based on the first query-independent index selection score; and
deriving a respective second query-independent index selection score according to criteria associated with the second automated resource selection process, and classifying the resource as to-be-indexed or as not-to-be-indexed based on the second query-independent index selection score.

5. The method of claim 4, further comprising, for each resource of the plurality of resources that matches the test query:
classifying the resource as to-be-indexed if the first query-independent index selection score satisfies a threshold, and otherwise classifying the resource as not-to-be-indexed; and
classifying the resource as to-be-indexed if the second query-independent index selection score satisfies a threshold, and otherwise classifying the resource as not-to-be-indexed.

6. The method of claim 4, further comprising, for each resource of the plurality of resources that matches the test query:
classifying the resource as to-be-indexed if the resource is one of a top predetermined number of resources according to the first query-independent index selection score, and otherwise classifying the resource as not-to-be-indexed; and
classifying the resource as to-be-indexed if the resource is one of a top predetermined number of resources according to the second query-independent index selection score, and otherwise classifying the resource as not-to-be-indexed.

7. The method of claim 4, wherein:
the criteria associated with the first automated resource selection process identifies a first plurality of index selection signals for use in deriving query-independent index selection scores; and
the criteria associated with the second automated resource selection process identifies a second plurality of index selection signals for use in deriving query-independent index selection scores.

8. The method of claim 1,
wherein identifying the one or more fresh resources includes identifying the one or more highest scoring fresh resources according to the query-specfic scores; and
wherein updating the query-to-resource mapping includes updating the query-to-resource mapping to include data that maps the query to the identified one or more highest scoring fresh resources.

9. A computer-readable storage medium storing instructions that when executed by one or more computers cause the one or more computers to perform a method comprising:
for each of a plurality of predetermined periodic time intervals, updating a query-to-resource mapping that associates each query of a group of queries with resources that match one or more of the queries, including, for each query in the group:
identifying fresh resources that match the query, wherein each fresh resource is associated with a respective discovery time in the respective time interval;
obtaining a respective query-specific score for each fresh resource that matches the query;
identifying one or more highest scoring fresh resources according to the query-specific scores; and
updating the query-to-resource mapping to include data that maps the query to the one or more highest scoring fresh resources.

10. The computer-readable storage medium of claim 9, wherein the method further comprises:
subsequent to an expiration of the plurality of predetermined periodic time intervals,
updating the group of queries by adding one or more new queries and removing one or more existing queries; and
updating the query-to-resource mapping using the updated group of queries.

11. The computer-readable storage medium of claim 9, wherein the method further comprises:
receiving a test query; and
generating, for the test query, a first group of resources corresponding to a first automated resource selection process and a second group of resources corresponding to a second automated resource selection process, wherein the generating includes:
identifying, using the query-to-resource mapping, a plurality of resources that match the test query;
determining, for each resource of the plurality of resources, whether the first automated resource selection process would classify the resource as to-be-indexed or not-to-be-indexed, and then identifying all resources classified as to-be-indexed as the first group of resources; and
determining, for each resource in the plurality of resources, whether the second automated resource selection process would classify the resource as to-be-indexed or not-to-be-indexed, and then identifying all resources classified as to-be-indexed as the second group of resources.

12. The computer-readable storage medium of claim 11, wherein, for each resource of the plurality of resources that matches the test query, the method further comprises:
deriving a respective first query-independent index selection score according to criteria associated with the first automated resource selection process, and classifying the resource as to-be-indexed or as not-to-be-indexed based on the first query-independent index selection score; and
deriving a respective second query-independent index selection score according to criteria associated with the second automated resource selection process, and classifying the resource as to-be-indexed or as not-to-be-indexed based on the second query-independent index selection score.

13. The computer-readable storage medium of claim 12, further comprising, for each resource of the plurality of resources that matches the test query:
classifying the resource as to-be-indexed if the first query-independent index selection score satisfies a threshold, and otherwise classifying the resource as not-to-be-indexed; and
classifying the resource as to-be-indexed if the second query-independent index selection score satisfies a threshold, and otherwise classifying the resource as not-to-be-indexed.

14. The computer-readable storage medium of claim 12, further comprising, for each resource of the plurality of resources that matches the test query:
classifying the resource as to-be-indexed if the resource is one of a top predetermined number of resources according to the first query-independent index selection score, and otherwise classifying the resource as not-to-be-indexed; and
classifying the resource as to-be-indexed if the resource is one of a top predetermined number of resources according to the second query-independent index selection score, and otherwise classifying the resource as not-to-be-indexed.

15. The computer-readable storage medium of claim 12, wherein:
the criteria associated with the first automated resource selection process identifies a first plurality of index selection signals for use in deriving query-independent index selection scores; and
the criteria associated with the second automated resource selection process identifies a second plurality of index selection signals for use in deriving query-independent index selection scores.

16. The computer-readable storage medium of claim 9,
wherein the method of identifying the one or more fresh resources includes identifying the one or more highest scoring fresh resources according to the query-specific scores; and
wherein the method of updating the query-to-resource mapping includes updating the query-to-resource mapping to include data that maps the query to the identified one or more highest scoring fresh resources.

17. A system comprising:
one or more computers configured to perform a method comprising:
for each of a plurality of predetermined periodic time intervals, updating a query-to-resource mapping that associates each query of a group of queries with resources that match one or more of the queries, including, for each query in the group:
identifying fresh resources that match the query, wherein each fresh resource is associated with a respective discovery time in the respective time interval;
obtaining a respective query-specific score for each fresh resource that matches the query;
identifying one or more highest scoring fresh resources according to the query-specific scores; and
updating the query-to-resource mapping to include data that maps the query to the one or more highest scoring fresh resources.

18. The system of claim 17, wherein the method further comprises:
subsequent to an expiration of the plurality of predetermined periodic time intervals,
updating the group of queries by adding one or more new queries and removing one or more existing queries; and
updating the query-to-resource mapping using the updated group of queries.

19. The system of claim 17, wherein the method further comprises:
receiving a test query; and
generating, for the test query, a first group of resources corresponding to a first automated resource selection process and a second group of resources corresponding to a second automated resource selection process, wherein the generating includes:
identifying, using the query-to-resource mapping, a plurality of resources that match the test query;
determining, for each resource of the plurality of resources, whether the first automated resource selection process would classify the resource as to-be-indexed or not-to-be-indexed, and then identifying all resources classified as to-be-indexed as the first group of resources; and
determining, for each resource in the plurality of resources, whether the second automated resource selection process would classify the resource as to-be-indexed or not-to-be-indexed, and then identifying all resources classified as to-be-indexed as the second group of resources.

20. The system of claim 19, wherein, for each resource of the plurality of resources that matches the test query, the method further comprises:
deriving a respective first query-independent index selection score according to criteria associated with the first automated resource selection process, and classifying the resource as to-be-indexed or as not-to-be-indexed based on the first query-independent index selection score; and
deriving a respective second query-independent index selection score according to criteria associated with the second automated resource selection process, and classifying the resource as to-be-indexed or as not-to-be-indexed based on the second query-independent index selection score.

21. The system of claim 20, further comprising, for each resource of the plurality of resources that matches the test query:
classifying the resource as to-be-indexed if the first query-independent index selection score satisfies a threshold, and otherwise classifying the resource as not-to-be-indexed; and
classifying the resource as to-be-indexed if the second query-independent index selection score satisfies a threshold, and otherwise classifying the resource as not-to-be-indexed.

22. The system of claim 20, further comprising, for each resource of the plurality of resources that matches the test query:
classifying the resource as to-be-indexed if the resource is one of a top predetermined number of resources according to the first query-independent index selection score, and otherwise classifying the resource as not-to-be-indexed; and
classifying the resource as to-be-indexed if the resource is one of a top predetermined number of resources according to the second query-independent index selection score, and otherwise classifying the resource as not-to-be-indexed.

23. The system of claim 20, wherein:
the criteria associated with the first automated resource selection process identifies a first plurality of index selection signals for use in deriving query-independent index selection scores; and
the criteria associated with the second automated resource selection process identifies a second plurality of index selection signals for use in deriving query-independent index selection scores.

24. The system of claim 17,
wherein the method of identifying the one or more fresh resources includes identifying the one or more highest scoring fresh resources according to the query-specific scores; and
wherein the method of updating the query-to-resource mapping includes updating the query-to-resource mapping to include data that maps the query to the identified one or more highest scoring fresh resources.
